(19) United States
(12) Patent Application Publication
(10) Pub. No.: US 2007/0260572 A1
(43) Pub. Date: Nov. 8, 2007

(54) INTERACTIVE DATA MANAGEMENT SYSTEM

(76) Inventor: John C. Boucard, Pasadena, CA (US)

Correspondence Address: CHRISTIE, PARKER & HALE, LLP, PO BOX 7068, PASADENA, CA, 91109-7068, US

(21) Appl. No.: 11/381,514

(22) Filed: May 3, 2006

(51) Int. Cl. G06F 17/30

(52) U.S. Cl. 707/1

(57) ABSTRACT

An interactive data management system that links an article to files pertaining to the article, the files being located in one or more storage mediums. The system outputs the files pertaining to the article including text, image, audio and video data without requiring a user to work through a hierarchal menu structure.

### BACKGROUND

This disclosure relates to interactive data management and, more particularly, to a system and device that provide simultaneous access to data located in one or more storage mediums.

Currently multimedia and other data content are distributed on storage media such as a CD, VCD or DVD, and have traditionally been viewed and listened to on a television set or monitor. The internet has added the ability to locate content by a uniform resource locator (URL). Usually data, audio and video content stored on a specific media are organized by hierarchical menus and can be selectively outputted using a remote access device such as an infrared (IR) remote control, mouse or keyboard. These devices typically have buttons or keys that allow the user to navigate through a hierarchal menu structure to select the desired content and activate the commands that enable the content to be presented.

Content, however, is often stored in more than one location and type of storage medium. Therefore, in order to present a complete user experience, related content must first be identified and then selectively outputted using an appropriate media player or storage device before the individual is presented with the content. For example, if a couple desires to remember their lives together they must gather all the photographs, videos, letters, e-mails and notes together, sort through the collection in a particular order and then later view the collection after it has been organized. This process can be very tedious and time consuming.

Additionally, content is also often stored with a passcode that can be used to limit access to files. However, younger children and adults that are allowed access to the content can be incapable of remembering or entering the passcode and are thereby prevented from accessing the contents of the files.

Accordingly, there is a need for a system utilizing dynamic articles with an identifier that can be used to access data where the data files are different, and process the data files in an order which is pre-set, and can be modified to access additional data. Moreover, it is desirable that the system can link to different types of data from disparate locations and various formats in a user selectable order without requiring the user to navigate through a hierarchal menu structure or collect the files prior to processing.

### SUMMARY

The present invention meets this need by providing a system utilizing dynamic articles with an identifier that can be used to access data where the data files are different, and process the data files in an order which is pre-set, and can be modified to access additional data. Further, the present invention can link to different types of data from disparate locations and various formats in a user selectable order without requiring the user to navigate through a hierarchal menu structure or collect the files prior to processing.

The invention is a system for linking articles to data comprising: a) a plurality of different articles, each article having a writable memory device, the memory device including an identifier and at least one external pointer specific for the article, wherein the identifier identifies the article and each external pointer links external data external to the memory device, the external data pertaining to the article, the memory device being capable of receiving additional external pointers; b) a memory device reader for reading the identifier and each external pointer on the memory device; c) memory means containing the external data pertaining to the articles; and d) an output device operably connected to the memory means for outputting the external data in response to the identifier and external pointers being read by the reader.

Typically the invention has a readable memory device including an identifier and at least one external pointer to stored data, wherein the stored data is linked to the identifier and the stored data pertains to the article; a readable memory separate from the readable memory device comprising at least a portion of the stored data; and a processor operatively linked to the readable memory, the reader that is operatively linked to the readable memory, and the output device that is operably connected to the reader, where the processor is programmed to receive the identifier and the at least one external pointer from the reader and output the stored data pertaining to the article in response thereto. Optionally, the readable memory device is remotely connected to the system. Preferably, the identifier is selected from the group consisting of a conductive ink trace, a resistor, a bar-code, a radio frequency identification (RFID) tag and a pin-out. Optionally, the memory device includes an internal pointer linking internal data on the memory device to the article, where the internal data pertains to the article, and multiple external pointers linking external data to the memory device.

Preferably the memory device is embedded in the article. Optionally, the memory device is attached to the article by: adhesive means selected from the group consisting of a glue, a tape and a putty; and mechanical means selected from the group consisting of a staple, a clip, and a tack.

In various versions of the invention, the article can be: an image and the external data when outputted produces at least one image; a fantasy figure and the external data when outputted produce at least one of the fantasy figure's powers, skills, abilities and weapons for use in game play; a piece of jewelry and the external data when outputted produces at least one of an image and audio pertaining to the jewelry; an iconic representation and the external data when outputted produces at least one of an image and audio pertaining to the iconic representation; a die and rolling the die randomly selects a portion of the external data that outputs an event pertaining to game play; a poster and a new pointer to external data is outputted to the memory device when the article is operably connected to the poster; a game piece and the external data when outputted produces a gaming event; or a greeting card and the external data when outputted produces at least one of an image and audio pertaining to the greeting card.

In another version of the invention the system comprises a device for linking an article to at least one file in data storage comprising a support, means for attaching the support to the object, memory supported by the base and storing an identifier and a plurality of pointers to external data, the identifier and pointers being capable of being read by a reader, wherein the identifier identifies the device and the pointers link to the at least one file, and a profile storing a sequence for outputting the at least one file linked to the pointers. Optionally, the external pointer links to a plurality of files in data storage.

The invention can be used for linking an article to at least one file in data storage by selecting the device, attaching the device to the article, coupling the memory to a reader for reading the identifier and the external pointer and modifying at least one pointer in the memory.

In another version of the invention at least one external pointer to a file in a readable memory device can be accessed by obtaining a readable memory device comprising an identifier and at least one external pointer to a file associated with the identifier, reading the identifier and the at least one external pointer from the readable memory device, accessing and outputting the file to an output device in response to reading the identifier and the external pointers. Preferably, some of the file is stored in readable memory separate from the readable memory device.

### DRAWINGS

These and other features, aspects and advantages of the present invention will become better understood with regard to the following description, appended claims, and accompanying drawings where:

FIG. 1 is an overall block diagram of an interactive data management system according to one version of the invention;

FIG. 2 is an enlarged view of an article for use in the interactive data management system illustrated in FIG. 1;

FIG. 3 is a detailed block diagram of the interactive data management system illustrated in FIG. 1; and

FIG. 4 is a flowchart showing steps of a method for using the interactive data management system illustrated in FIG. 1.

### DESCRIPTION

Methods and devices that implement the embodiments of the various features of the invention will now be described with reference to the drawings. The drawings and the associated descriptions are provided to illustrate embodiments of the invention and not to limit the scope of the invention. As used in this disclosure, except where the context requires otherwise, the term “comprise” and variations of the term, such as “comprising”, “comprises” and “comprised” are not intended to exclude other additives, components, integers or steps.

In the following description, certain terminology is used to describe certain features of one or more embodiments of the invention.

The term “file” refers to a collection of information that is stored in sequences of bits. For example, a file can include documents, computer programs, text, pictures, video, locations or sounds. A file can be the contents of a file, a portion of a file, a page in memory, a pointer to another file location, a program executable by a processor, an object in an object-oriented program, a digital message, a digital scanned image, a part of a video or audio signal, or any other entity which can be represented by a sequence of bits.

The term “memory device” refers to any device capable of storing information, including dynamic random access memory (DRAM) and includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals).

The term “pertaining” refers to data that belongs as a part, a member, an accessory, a product, an attribute, a feature, or a function that is appropriate to an article.

The term “input/output” (I/O) with regard to a device or a module refers to a collection of interfaces that different functional units, or sub-systems, of an information processing system use to communicate with each other, or the signals sent through those interfaces. For example, an input sub-system includes a keyboard, a computer mouse, a microphone, a digital camera, radio frequency identification device (RFID) and a conductive ink device. An example of an output sub-system includes a computer monitor, a TV, a DVD player, an infra-red (IR) remote control device and a cell phone.

The term “profile” is used to define configuration settings and other data associated with an individual user or with a group, such as family, business, a legal case or a game and are typically comprised of pointers to files.

The term “iconic representation” is an image, picture, sign or likeness that stands for an object by signifying or representing it by analogy. Iconic representations can be cast in metal, carved in stone, embroidered on cloth, done in mosaic work, printed on paper or metal.

The present invention can be implemented by hardware, software, firmware, middleware and/or microcode. When implemented in software, firmware, middleware or microcode, the program code or code segments to perform the necessary tasks can be stored in a machine-readable medium. A processor can perform the necessary tasks. A code segment can represent a procedure, a function, a subprogram, a program, a routine, a subroutine, a module, a software package, a class, or a combination of instructions, data structures, or program statements. A code segment can be coupled to another code segment or a hardware circuit by passing and/or receiving information, data, arguments, parameters or memory contents. Information, arguments, parameters and data can be passed, forwarded, or transmitted through memory sharing, message passing, token passing and network transmission.

Various embodiments provide a system, method and device for interactive data management. There are, however, alternative embodiments that can be used for interactive data management and this disclosure is merely illustrative of and not restrictive on the broad invention.

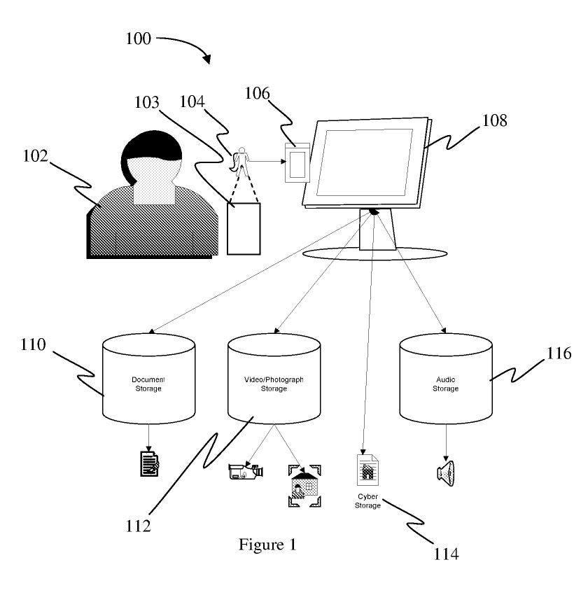

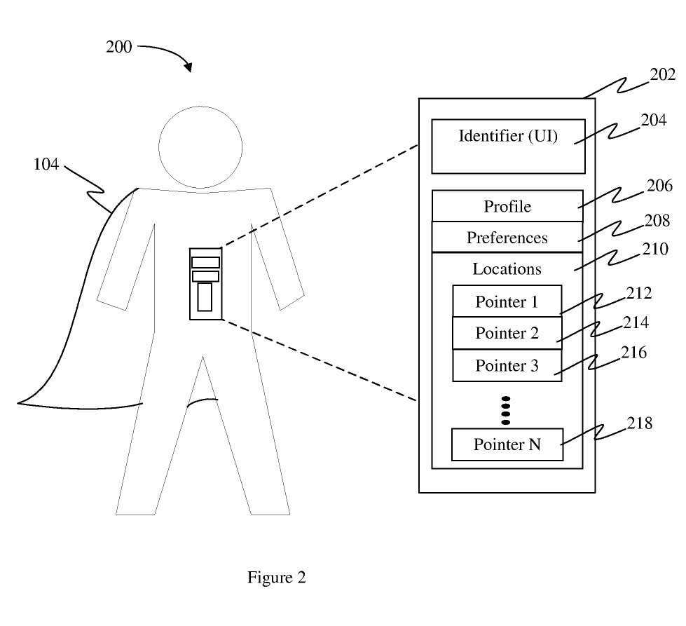

With reference to FIG. 1 and FIG. 2 is an interactive data management system 100 according to the present invention. The system 100 comprises a memory device 103, an article 104, a reader 106, a display 108, and files 110, 112, 114 and 116 located in diverse and remote storage locations. A memory device 202 comprises an identifier 204 to identify the article, a profile 206 containing a sequence for outputting the files 110-116 linked by one or more pointers 212, 214,216 and 218 and preferences 208 that can limit the pointers 212-218 that can be stored in the memory device 202. A user 102 places the article 104 in proximity to the reader 106 where the article's 104 identifier 204, the profile 206, the preferences and the pointers 212-218 are read from the article 104. The system 100 retrieves the files 110-116 from the various storage locations and outputs the files 110-116 in a pre-set order stored in the profile 206 using an appropriate application or device connected to the system 100. The device 202 can be embedded into the article 104 or attached to the article 104. The device 202 can be attached to the article 104 by taping, clipping, tacking or gluing the device 202 to the article 104. Preferably the device 202 is embedded in the article 104 during manufacture. The files 110-116 can be linked to the article 104 through the addition, deletion or modification of one or more pointers 212-218.

For example, if the article 104 is an iconic representation of a heart for Valentines Day the files 110-116 pertaining to the iconic representation 104 can include a romantic music audio file 116, a video file 112, a URL 114 for a web site and a text 110. When the iconic representation 104 is connected to the reader 106, the article's identifier and the pointers to the files 110-116 are read from the iconic representation 104. The files 110-116 are retrieved, processed and outputted in a preset order without input from the user 102 of the iconic representation 104. For example, the user 102 passes the heart shaped iconic representation 104 across the reader 106 and simultaneously the romantic music audio file 116 begins to play, the video file 112 is shown on the display 108, and the retrieved text file 110 of a poem is scrolled across the display 108. Additionally, once the video file 112 and the text file 110 have finished execution, a web page 114 that displays reservations made for a romantic Caribbean cruise is shown on the display 108.

In another example, a manufacturer of a role playing game embeds the device 202 into the fantasy figure article 104. When the user 102 connects the article 104 to the reader 106 the identifier 204 is read by the system 100. The system 100 outputs the pointers 212-218 to the files that pertain to the fantasy figure article 104. For example, a superhero fantasy figure's identification 204 only accesses a pointer 210 to the super strength file 110. The combination of the identifier and the pointer would not be allowed to access the file containing invisibility. Optionally, the user 102 can be presented with a selection screen (not shown) of upgrades pertaining to the fantasy figure article 104 along with the files currently linked to the article 104. Alternatively, the system 100 has a database (not shown) of files pertaining to the fantasy figure article 104 linked with the identifier 204 and can automatically upgrade the embedded device 202 with a non-duplicate file pointer 212-218.

In another example of the present invention, the profile 206 and the files 212-218 that pertain to the article 104 can be set by a user 102. For example, the user 102 has a photograph (not shown) of a personal experience. The user 102 attaches the device 202 to the photograph using glue, tape or putty. Then, the user 102 locates files that pertain to the photographic article 104 such as, for example, music that was playing when the picture was taken that is stored on a compact disc (CD), articles from the internet about the geographical location of the area where the picture was taken and additional digital photos from the same time period that are stored on a secure digital card. The user 102 then modifies the pointers 212-218 to point to the locations where the files are stored 110-116 and links the device 202 identifier 204 with the files that pertain to the article. The user 102 has constructed a personalized experience for the photographic article 104 that can be easily replayed by connecting the photographic article 104 to the reader 106 without searching for all the related files that pertain to the photograph.

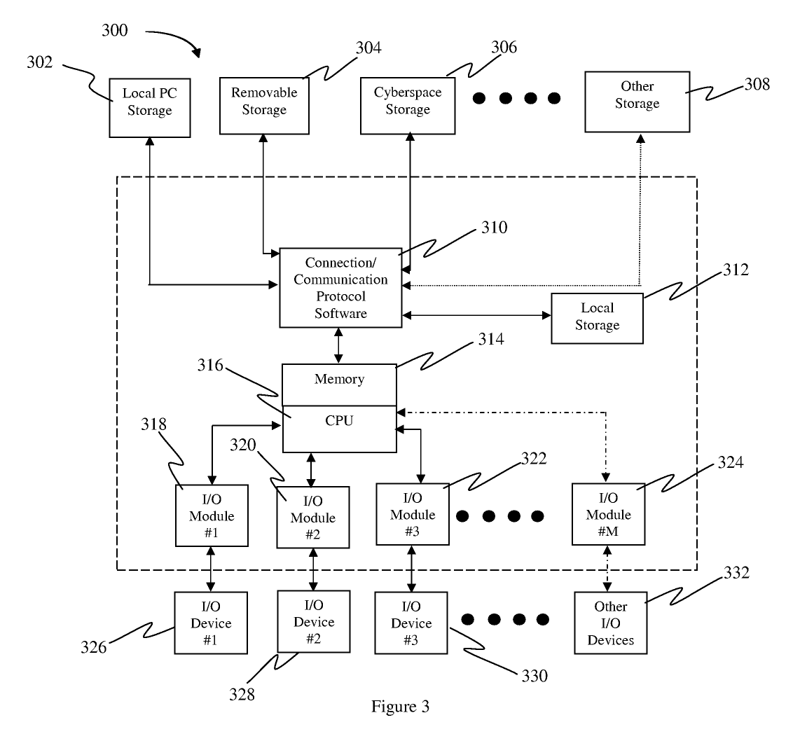

FIG. 3 is a detailed block diagram of the interactive data management system illustrated in FIG. 1. The system comprises a CPU 316, a memory 314, an external storage 302, 304, 306, and 308, an internal I/O module 318, 320, 322, and 324, and an external I/O device 326, 328, 330, and 332, where I/O device #1 326 is the reader 106 for the device 104 and I/O module #2 320 is a display device

A connection communications protocol software 310 is operably connected to the memory 314 and processor 316. The connection communications protocol software 310 is communicatively coupled to external remote storage 302 through 308 to retrieves files stored in those locations. The retrieved files are stored in memory 314. Optionally the system 300 can contain a local storage 312 that comprises files to be executed, which have been gathered from the remote locations 302 through 308. The various files are processed according to the profile XXX stored in the device 202. For example, an audio file (not shown) can be executed by CPU 316 and sent to I/O module #2 320 for outputting to I/O device #2 328. A speaker (not shown), and a web page retrieved from cyber storage 306 is output by CPU 316 using I/O module #3 322 and shown on I/O device #3 330, a display (not shown).

The reader 106 is configured to access files in a variety of storage locations 302 through 308 and comprises I/O modules 318-324, a CPU 316, memory 314 and a connection/communication protocol software module 310. As shown in FIG. 3, the I/O modules 318-324 are communicatively coupled to I/O devices 326-332, respectively, to output information sent from the CPU 316 and memory 314.

The connection/communication protocol software module 310 interfaces with CPU 316, memory 314 and file storage 302-308, to select files pertaining to the article 104 in response to commands received from the article 104 and outputting the file contents on one or more I/O devices 326-332.

The files 302-308 pertaining to the article 104 are addresses encoded as a universal resource locator (URL). The system 300 accesses the files using the URL and outputs the files 302-308 pertaining to the article by I/O devices 326-332.

In one embodiment (not shown), the I/O device 326 can be a remote control device, for example a television remote control, that contains an RFID code identifying the article and a URL that points to files related to the remote control. The user can point the remote control to a set-top box configured in accordance with the present invention that would retrieve and play a movie file or a selected scene from a movie file on the user's television without the need to navigate through the standard television hierarchical menu system. Other I/O devices 326-332 can include, but are not limited to, a digital camera, a cell phone, a TV, a DVD player, a microphone, a computer/monitor, a keyboard or mouse as will be understood by those with skill in the art, with reference to this disclosure.

A CPU 316 outputs files stored in locations 302-308 in response to receiving an identifier and pointers to the external files pertaining to an article 104 from an I/O device 326-332. The I/O devices 326-332 comprise an RFID device, a conductive ink device, or an infra-red (IR) code device. Additionally, physical objects such as trading cards, wearable jewelry, photographs, plush toys and similar objects can be modified to control and access files in accordance with the present invention to manipulate files for viewing on a television set, a personal computer, a DVD player, or a cell phone. A “Power Ring” or a “Decoder Ring” for children can also be fabricated, using the principles of the invention, to interface and communicate with both a television set and the Internet. This would enable manufacturers to provide files to children that are not capable of navigating the internet, DVD menus, or television programming.

File storage 302-308 can include, but is not limited to, one or more disc drives in a local PC 302, removable storage devices 304. For example tape drive and flash memory devices, cyberspace storage 306, internet and or intranet 114 file storage. Additionally, other file storage locations 308 can also be used for file storage. For example broadcast television channels, mp3 players, cell phones and other audio visual devices as will be understood by those with skill in the art, with reference to this disclosure.

The invention can be employed to access directly a variety of files pertaining to an article. Additionally, the invention can be used to directly access a single file by storing the location of that file at a specific address and an identifier in the article itself.

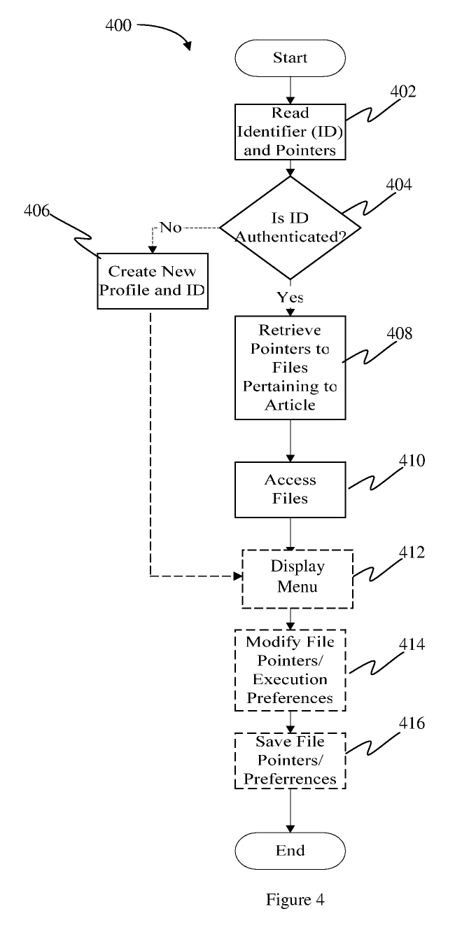

FIG. 4 is a flowchart 400 showing some steps of a method for using the interactive data management system 100 illustrated in FIG. 1. First, an identifier is read 402 from the device 202 attached or embedded in the article 104. Next, a determination is made if the identifier 204 has been stored 404. Then, if the identifier 204 has not been stored, a new identifier 204 and a new profile 206 comprising executing preferences 208 and pointers 210-216 is created 406. Next, if the identifier 204 is stored in the system, the pointers 210-218 to the files pertaining to the article 104 and the identifier 204 are retrieved 408 from data storage 302-308. Then, the files are executed 410 according to the preferences 208 stored in the device 202. Next, a menu is displayed 412 to enable the user to modify 414 the files pertaining to the article. Then, the external pointers to the files pertaining to the article are saved to the article.

Although the present invention has been described in considerable detail with reference to certain preferred versions thereof, other versions are possible. Therefore, the spirit and scope of the appended claims should not be limited to the description of the preferred versions contained herein.

All features disclosed in the specification, including the claims, abstracts, and drawings, and all the steps in any method or process disclosed, can be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” for “step” clause as specified in 35 U.S.C. § 112.

What is claimed is:

1. A system for linking articles to data comprising:
a) a plurality of different articles, each article having a writable memory device, the memory device including an identifier and at least one external pointer specific for the article, wherein the identifier identifies the article and each external pointer links external data external to the memory device, the external data pertaining to the article, the memory device being capable of receiving additional external pointers;
b) a memory device reader for reading the identifier and each external pointer on the memory device;
c) memory means containing the external data pertaining to the articles; and
d) an output device operably connected to the memory means for outputting the external data in response to the identifier and external pointers being read by the reader.

2. The system of claim 1 further comprising:
a) a readable memory device including an identifier and at least one external pointer to stored data, wherein the stored data is linked to the identifier and the stored data pertains to the article;
b) a readable memory separate from the readable memory device comprising at least a portion of the stored data; and
c) a processor operatively linked to the readable memory, the reader and the output device;
wherein the processor is programmed to:
i) receive the identifier and the at least one external pointer from the reader; and
ii) output the stored data pertaining to the article in response thereto.

3. The system of claim 1, wherein the reader is operatively linked to the readable memory;

4. The system of claim 1, wherein the output device is operably connected to the reader.

5. The system of claim 1, wherein the readable memory device is remotely connected to the system.

6. The system of claim 1, wherein the identifier is selected from the group consisting of a conductive ink trace, a resistor, a bar-code, a radio frequency identification (RFID) tag and a pin-out.

7. The system of claim 1, wherein the memory device includes an internal pointer linking internal data on the memory device to the article, the internal data pertaining to the article.

8. The system of claim 1, wherein the memory device comprises multiple external pointers linking external data to the memory device.

9. The system of claim 1, wherein the memory device is embedded in the article.

10. The system of claim 1, wherein the memory device is attached to the article by adhesive means.

11. The system of claim 1, wherein the article is an image and the external data when outputted produces at least one image.

12. The system of claim 1, wherein the article is a fantasy figure and the external data when outputted produce at least one of the fantasy figure's powers, skills, abilities and weapons for use in game play.

13. The system of claim 1, wherein the article is a piece of jewelry and the external data when outputted produces at least one of an image and audio pertaining to the jewelry.

14. The system of claim 1, wherein the article is an iconic representation and the external data when outputted produces at least one of an image and audio pertaining to the iconic representation.

15. The system of claim 1, wherein the article is a die and rolling the die randomly selects a portion of the external data that outputs an event pertaining to game play.

16. The system of claim 1, wherein the article is a poster and a new pointer to external data is outputted to the memory device when the article is operably connected to the poster.

17. The system of claim 1, wherein the article is a game piece and the external data when outputted produces a gaming event.

18. The system of claim 1, wherein the article is a greeting card and the external data when outputted produces at least one of an image and audio pertaining to the greeting card.

19. The system of claim 1, wherein the identifier denies access to pointers to external data that can be written to the memory device.

20. The system of claim 1, wherein the identifier allows access to pointers to external data and the external data.

21. A device for linking an article to at least one file in data storage comprising:
a) a support;
b) means for attaching the support to the object;
c) memory supported by the base and storing an identifier and a plurality of pointers to external data, the identifier and pointers being capable of being read by a reader, wherein the identifier identifies the device and the pointers link to the at least one file; and
d) a profile storing a sequence for outputting the at least one file linked to the pointers.

22. The device of claim 21, wherein the external pointer links to a plurality of files in data storage.

23. The device of claim 21, wherein the attachment means is selected from the group consisting of adhesive and mechanical means.

24. The device of claim 21, wherein the mechanical means is selected from the group consisting of a staple, a clip, and a tack.

25. The device of claim 21, wherein the adhesive means is selected from the group consisting of a glue, a tape and a putty.

26. The device of claim 21, wherein the memory stores a plurality of external pointers capable of being read by a reader, and each external pointer links to a data file.

27. The device of claim 21, wherein the identifier is selected from the group consisting of a conductive ink trace, a resistor, a bar-code, a radio frequency identification (RFID) tag and a pin-out.

28. A method for linking an article to at least one file in data storage comprising the steps of:
a) selecting the device of claim 21; and
b) attaching the device to the article.

29. The method of claim 28 comprising the additional steps of:
a) coupling the memory to a reader for reading the identifier and the external pointer; and
b) modifying at least one pointer in the memory.

30. A method for accessing at least one external pointer to a file in a readable memory device comprising the steps of:
a) obtaining a readable memory device comprising an identifier and at least one external pointer to a file associated with the identifier;
wherein at least some of the file is stored in readable memory separate from the readable memory device;
b) reading the identifier and the at least one external pointer from the readable memory device; and
c) accessing the file and outputting the file to an output device in response to reading the identifier and the external pointers.

31. A system for linking an article to data comprising:
a) an article having a writable memory device therein, the memory device including an identifier and a pointer specific for the article, wherein the identifier identifies the article and the pointer links to data external to the memory device, the external data pertaining to the article, the memory device being capable of having pointers written therein;
b) a memory device reader for reading the identifier and the pointer on the memory device;
c) memory means containing data pertaining to the articles; and
d) an output device operably connected to the memory means for outputting the data in response to the identifier and pointer being read by the reader.
